(19) United States
(12) Patent Application Publication
(10) Pub. No.: US 2024/0386049 A1
(43) Pub. Date: Nov. 21, 2024

(54) SYSTEM AND METHOD FOR CONVERSATIONAL SHOPPING BASED ON MACHINE LEARNING

(71) Applicant: Walmart Apollo, LLC, Bentonville, AR (US)

(72) Inventors: Neeraj Agrawal, Shahganj (IN); Sumit Kumar Dutta, Bangalore (IN)

(21) Appl. No.: 18/633,828

(22) Filed: Apr. 12, 2024

Related U.S. Application Data
(60) Provisional application No. 63/502,708, filed on May 17, 2023.

(51) Int. Cl. G06F 16/532; G06F 40/20

(52) U.S. Cl. CPC G06F 16/532; G06F 40/20

(57) ABSTRACT

Systems and methods conversational shopping based on machine learning using both text and image data are disclosed. In some embodiments, a disclosed method includes: obtaining, from a computing device, a search request identifying a reference image representing a first product and a textual query associated with the reference image; computing a text embedding in an embedding space based on the textual query; computing an image embedding in the embedding space based on the reference image; determining, based on at least one machine learning model, a target image representing a second product based on the text embedding and the image embedding; and transmitting, to the computing device, the target image in response to the search request.

### CROSS-REFERENCE TO RELATED APPLICATION

This application claims benefit to U.S. Provisional Application Ser. No. 63/502,708, entitled “SYSTEM AND METHOD FOR CONVERSATIONAL SHOPPING BASED ON MACHINE LEARNING,” filed on May 17, 2023, the disclosure of which is incorporated herein by reference in its entirety.

### TECHNICAL FIELD

This application relates generally to conversational shopping and, more particularly, to systems and methods for conversational shopping based on machine learning using both text and image data.

### BACKGROUND

Conversational shopping based on a chatbot will have a huge impact on e-commerce. But existing conversation-based item retrieval systems are not natural, and their filters are not nearly enough. In addition, these systems use complicated category specific jargons which customers are not familiar with.

For example, one common problem for a customer shopping furniture is that the customer is not able to visualize a piece of furniture as part of a big furnished picture. A natural way a customer shops is having a reference image in mind and expressing the customer's needs on top of it. An existing item discovery in e-commerce is performed using either textual search having hardcoded filters and unfamiliar jargons, or voice based search using rule-based flows for emulating conversations. These methods do not allow customers to converse naturally or build a furnished room. Further, the customers are unable to discover and visualize multiple categories of furniture or multiple categories of products together. As such, it is desirable to have a user friendly conversation-based item retrieval system that can avoid the above drawbacks.

### SUMMARY

The embodiments described herein are directed to systems and methods for automatic conversational shopping based on machine learning using both text and image data.

In various embodiments, a system including a non-transitory memory configured to store instructions thereon and at least one processor is disclosed. The at least one processor is configured to read the instructions to: obtain, from a computing device, a search request identifying a reference image representing a first product and a textual query associated with the reference image; compute a text embedding in an embedding space based on the textual query; compute an image embedding in the embedding space based on the reference image; determine, based on at least one machine learning model, a target image representing a second product based on the text embedding and the image embedding; and transmit, to the computing device, the target image in response to the search request.

In various embodiments, a computer-implemented method is disclosed. The computer-implemented method includes: obtaining, from a computing device, a search request identifying a reference image representing a first product and a textual query associated with the reference image; computing a text embedding in an embedding space based on the textual query; computing an image embedding in the embedding space based on the reference image; determining, based on at least one machine learning model, a target image representing a second product based on the text embedding and the image embedding; and transmitting, to the computing device, the target image in response to the search request.

In various embodiments, a non-transitory computer readable medium having instructions stored thereon is disclosed. The instructions, when executed by at least one processor, cause at least one device to perform operations including: obtaining, from a computing device, a search request identifying a reference image representing a first product and a textual query associated with the reference image; computing a text embedding in an embedding space based on the textual query; computing an image embedding in the embedding space based on the reference image; determining, based on at least one machine learning model, a target image representing a second product based on the text embedding and the image embedding; and transmitting, to the computing device, the target image in response to the search request.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide conversational shopping based on machine learning, in accordance with some embodiments of the present teaching.

FIG. 2 is a block diagram of an item recommendation computing device, in accordance with some embodiments of the present teaching.

FIG. 3 is a block diagram illustrating various portions of an item recommendation system, in accordance with some embodiments of the present teaching.

FIG. 4 is a block diagram illustrating various portions of an item recommendation computing device, in accordance with some embodiments of the present teaching.

FIG. 5 illustrates an exemplary process to generate training data for conversational shopping, in accordance with some embodiments of the present teaching.

FIG. 6 illustrates an example of attribute extraction from an item title, in accordance with some embodiments of the present teaching.

FIG. 7 illustrates an example of vocabulary resolution to map jargons to user friendly keywords, in accordance with some embodiments of the present teaching.

FIG. 8A illustrates an exemplary caption generation process to generate a direct caption for a first candidate image pair, in accordance with some embodiments of the present teaching.

FIG. 8B illustrates another exemplary caption generation process to generate a relative caption for a second candidate image pair, in accordance with some embodiments of the present teaching.

FIG. 8C illustrates yet another exemplary caption generation process to generate a negative caption for a third candidate image pair, in accordance with some embodiments of the present teaching.

FIG. 9 illustrates an exemplary process for extracting attributes based on text and image data of some item, in accordance with some embodiments of the present teaching.

FIG. 10 illustrates an exemplary process for training a machine learning model and using the model during inference to generate a target image, in accordance with some embodiments of the present teaching.

FIG. 11 illustrates an exemplary process for automatic conversational shopping based on an item recommendation system, in accordance with some embodiments of the present teaching.

FIG. 12A and FIG. 12B illustrate another exemplary process for automatic conversational shopping based on an item recommendation system, in accordance with some embodiments of the present teaching.

FIG. 13 is a flowchart illustrating an exemplary method for providing item recommendation to enable automatic conversational shopping based on machine learning, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Chatbots are conversational applications that often plug into other applications and services (e.g., virtual personal assistants, schedulers, reminders, ordering systems, retail websites etc.). These chatbots provide users a communication interface to these other applications and services, aiming to provide an interaction that mimics an experience of interacting with a real person, and become more and more popular in e-commerce to enable a conversational shopping, i.e. conversation-based shopping.

One goal of various embodiments in the present teaching is to provide a unique way for customers to discover desired products efficiently, and put a discovered product in a complete environment, e.g. putting a piece of furniture in a complete furnished room. In some embodiments, a customer may submit both an image and a query, where the query refers to the image. For example, the customer may submit an image of a product, and submit a query to search for similar products but with a different feature, e.g. different color, different material, etc. This is a challenging task as it requires a synergistic understanding of both image and text together, and requires specific type of labelled data. A disclosed system according to some embodiments can generate this type of labelled data automatically without manually crowd labelling, and build a conversational recommendation system. This conversational recommendation system can be used for different categories. For example, for furniture category, the conversational recommendation system can help customers to build a furnished room to observe the recommended item.

In some embodiments, the system enables conversational shopping using simplified vocabulary. For example, the system can map a category specific jargon to one or more user friendly keywords, to improve effectiveness and efficiency for interactive item retrieval. This enables a customer to converse shopping needs with natural language and/or friendly jargons.

In some embodiments, this user friendly conversation-based product retrieval system can take a reference image and a user's textual feedback on top of the reference image, to understand an intent of the user. For example, a user might upload an image of fluffy chair and input a text including “need similar chair but less fluffiness.” The disclosed system can understand the requirement and give the user desired product with a target image.

In some embodiments, the disclosed system provides a new discovery experience which enables users to converse with a chatbot online and communicate their furniture needs using voice or text, e.g. allowing them to discover multiple furnishing aspect of a room together. The disclosed system may create training data including labelled data in a unique format, e.g. <reference image, target image, reference text>, and utilize this training labelled data to train a machine learning model to enable conversational shopping in e-commerce. This method can be extended and scaled to multiple categories in ecommerce.

Furthermore, in the following, various embodiments are described with respect to methods and systems for enabling conversational shopping based on machine learning. In some embodiments, a disclosed method includes: obtaining, from a computing device, a search request identifying a reference image representing a first product and a textual query associated with the reference image; computing a text embedding in an embedding space based on the textual query; computing an image embedding in the embedding space based on the reference image; determining, based on at least one machine learning model, a target image representing a second product based on the text embedding and the image embedding; and transmitting, to the computing device, the target image in response to the search request.

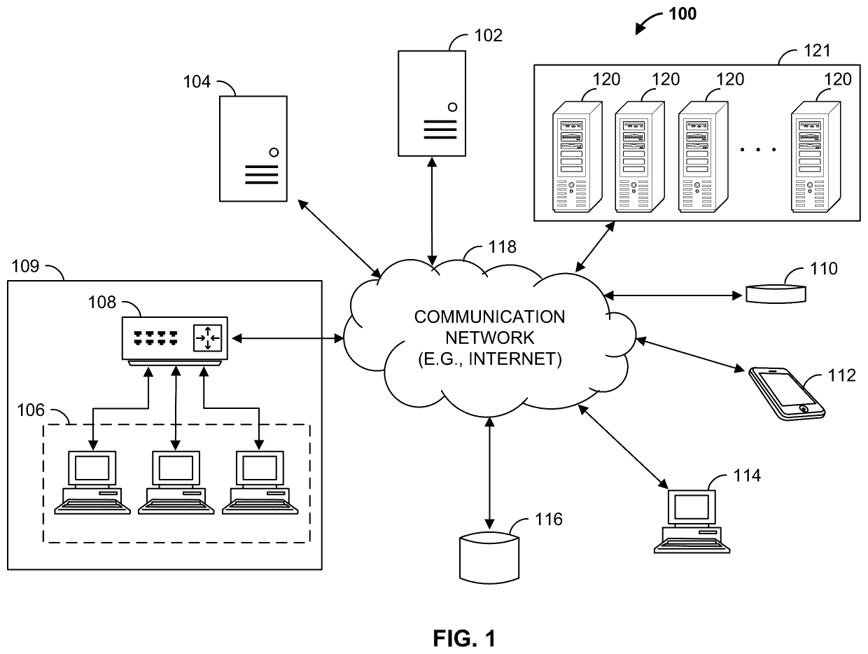

Turning to the drawings, FIG. 1 is a network environment 100 configured to provide conversational shopping based on machine learning, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an item recommendation computing device 102 (e.g., a server, such as an application server), a web server 104, a cloud-based engine 121 including one or more processing devices 120, workstation(s) 106, a database 116, and one or more customer computing devices 110, 112, 114 operatively coupled over the network 118. The item recommendation computing device 102, the web server 104, the workstation(s) 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the item recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the item recommendation computing device 102.

In some examples, each of the multiple customer computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites. In some examples, the item recommendation computing device 102, the processing devices 120, and/or the web server 104 are operated by a retailer, and the multiple customer computing devices 110, 112, 114 are operated by customers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109, for example. The workstation(s) 106 can communicate with the item recommendation computing device 102 over the communication network 118. The workstation(s) 106 may send data to, and receive data from, the item recommendation computing device 102. For example, the workstation(s) 106 may transmit data identifying items purchased by a customer at the store 109 to item recommendation computing device 102.

Although FIG. 1 illustrates three customer computing devices 110, 112, 114, the network environment 100 can include any number of customer computing devices 110, 112, 114. Similarly, the network environment 100 can include any number of the item recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the first customer computing device 110, the second customer computing device 112, and the Nth customer computing device 114 may communicate with the web server 104 over the communication network 118. For example, each of the multiple computing devices 110, 112, 114 may be operable to view, access, and interact with a website, such as a retailer's website, hosted by the web server 104. The web server 104 may transmit user session data related to a customer's activity (e.g., interactions) on the website. For example, a customer may operate one of the customer computing devices 110, 112, 114 to initiate a web browser that is directed to the website hosted by the web server 104. The customer may, via the web browser, search for items, view item advertisements for items displayed on the website, and click on item advertisements and/or items in the search result, for example. The website may capture these activities as user session data, and transmit the user session data to the item recommendation computing device 102 over the communication network 118. The website may also allow the operator to add one or more of the items to an online shopping cart, and allow the customer to perform a “checkout” of the shopping cart to purchase the items. In some examples, the web server 104 transmits purchase data identifying items the customer has purchased from the website to the item recommendation computing device 102.

In some examples, the item recommendation computing device 102 may execute one or more models (e.g., algorithms), such as a machine learning model, deep learning model, statistical model, etc., to determine recommended items to advertise to the customer (i.e., item recommendations). The item recommendation computing device 102 may transmit the item recommendations to the web server 104 over the communication network 118, and the web server 104 may display one or more of the recommended items on the website to the customer. For example, the web server 104 may display the recommended items to the customer on a homepage, a catalog webpage, an item webpage, a window or interface of a chatbot, a search results webpage, or a post-transaction webpage of the website (e.g., as the customer browses those respective webpages).

In some examples, the web server 104 transmits a recommendation request to the item recommendation computing device 102. The recommendation request may be a search request sent together with a search query provided by the customer (e.g., via a search bar of the web browser, or via a conversational interface of chatbot), or a standalone recommendation request provided by a processing unit in response to the user's action on the website, e.g. interacting (e.g., engaging, clicking, or viewing) with one or more items, adding one or more items to cart, purchasing one or more items, opening or refreshing a homepage. In some examples, the search request is also sent together with a reference image, which represents a reference product associated with the search query.

In one example, a customer selects an item on a website hosted by the web server 104, e.g. by clicking on the item to view its product description details, by adding it to shopping cart, or by purchasing it. The customer may submit a reference query referring to the selected item, e.g. a query seeking an item similar to the selected item but with one or more different features. In response to receiving the request, the item recommendation computing device 102 may execute the one or more processors to determine some items that include these desired features and are the same as or very close to the selected item. The item recommendation computing device 102 may transmit some or all of the recommended items to the web server 104 to be displayed to the customer.

In another example, a customer submits a first query on a website hosted by the web server 104, e.g. by entering the first query in a search bar of a webpage or a chatbot. The web server 104 may send a first search request to the item recommendation computing device 102. In response to receiving the first search request, the item recommendation computing device 102 may execute the one or more processors to determine search results including items matching the first query, and transmit the search results including recommended items to the web server 104 to be displayed to the customer. The customer may be interested in one item in the search results, but want to twist it a little bit. For example, the customer may click on an image of the item, to submit the image as a reference image, and enter a second query in a search bar of the webpage or the chatbot, where the second query refers to the reference image to seek another item that is similar to the clicked item in the reference image but with one or more different features. The web server 104 may send a second search request to the item recommendation computing device 102. In response to receiving the second search request, the item recommendation computing device 102 may execute the one or more processors to determine recommended items that include these desired features and are the same as or very close to the clicked item in the reference image, and transmit some or all of the recommended items to the web server 104 to be displayed to the customer. This process can go on as the customer may select one of the newly recommended items as a reference and submit a third query associated with the newly selected item, to look for another item.

In yet another example, a customer may upload a reference image of a product and submit a query seeking a similar product but with some conditions, e.g. by entering the query in a search bar of a webpage or a chatbot on a website hosted by the web server 104. The web server 104 may send a search request to the item recommendation computing device 102. In response to receiving the search request, the item recommendation computing device 102 may execute the one or more processors to determine recommended items that meet these conditions and are the same as or very close to the product in the reference image, and transmit some or all of the recommended items to the web server 104 to be displayed to the customer. This process can go on as the customer may select one of the newly recommended items as a reference and submit another query associated with the newly selected item, to look for another item.

The item recommendation computing device 102 is further operable to communicate with the database 116 over the communication network 118. For example, the item recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the item recommendation computing device 102, in some examples, the database 116 can be a local storage device, such as a hard drive, a non-volatile memory, or a USB stick. The item recommendation computing device 102 may store purchase data received from the web server 104 in the database 116. The item recommendation computing device 102 may also receive from the web server 104 user session data identifying events associated with browsing sessions, and may store the user session data in the database 116.

In some examples, the item recommendation computing device 102 generates training data for a plurality of models (e.g., machine learning models, deep learning models, statistical models, algorithms, etc.) based on attribute data, vocabulary data, image data, caption data, historical user session data, search data, purchase data, catalog data, and/or advertisement data for the users. The item recommendation computing device 102 trains the models based on their corresponding training data, and the item recommendation computing device 102 stores the models in a database, such as in the database 116 (e.g., a cloud storage).

The models, when executed by the item recommendation computing device 102, allow the item recommendation computing device 102 to determine item recommendations to be displayed to a customer. For example, the item recommendation computing device 102 may obtain the models from the database 116. The item recommendation computing device 102 may then receive, in real-time from the web server 104, a search request identifying a reference image and an associated query submitted by the customer interacting with a website. In response to receiving the search request, the item recommendation computing device 102 may execute the models to determine recommended items to display to the customer.

In some examples, the item recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, item recommendation computing device 102 may generate ranked item recommendations for items to be displayed on the website to a user.

In some examples, each of the recommended items is displayed to the customer with a target image representing the recommended item. The recommended items are determined to be best match to a combination the reference image and the submitted query, where their matching scores are beyond a predetermined threshold. When there are multiple recommended items, they may be ranked according to their respective matching scores to form a ranked list of recommended items based on some ranking and filtering models.

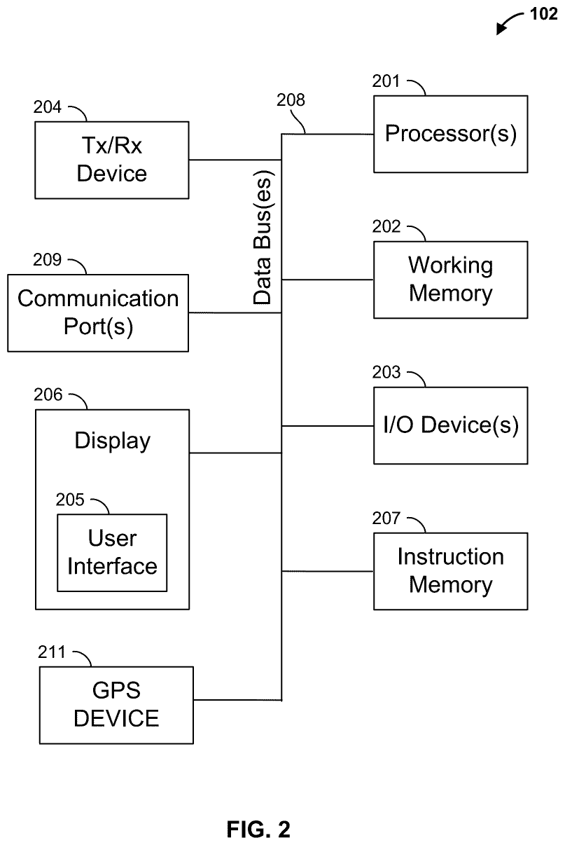

FIG. 2 illustrates a block diagram of an item recommendation computing device, e.g. the item recommendation computing device 102 of FIG. 1, in accordance with some embodiments of the present teaching. In some embodiments, each of the item recommendation computing device 102, the web server 104, the workstation(s) 106, the multiple customer computing devices 110, 112, 114, and the one or more processing devices 120 in FIG. 1 may include the features shown in FIG. 2. Although FIG. 2 is described with respect to the item recommendation computing device 102. It should be appreciated, however, that the elements described can be included, as applicable, in any of the item recommendation computing device 102, the web server 104, the workstation(s) 106, the multiple customer computing devices 110, 112, 114, and the one or more processing devices 120.

As shown in FIG. 2, the item recommendation computing device 102 can include one or more processors 201, a working memory 202, one or more input/output devices 203, an instruction memory 207, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the item recommendation computing device 102. The working memory 202 can be a random access memory (RAM) such as a static random access memory (SRAM) or dynamic random access memory (DRAM), or any other suitable memory.

The input-output devices 203 can include any suitable device that allows for data input or output. For example, the input-output devices 203 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the item recommendation computing device 102. For example, the user interface 205 can be a user interface for an application of a retailer that allows a customer to view and interact with a retailer's website. In some examples, a user can interact with the user interface 205 by engaging the input-output devices 203. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the item recommendation computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the item recommendation computing device 102 may determine a local geographical area (e.g., town, city, state, etc.) of its position. Based on the geographical area, the item recommendation computing device 102 may determine relevant trend data (e.g., trend data identifying events in the geographical area).

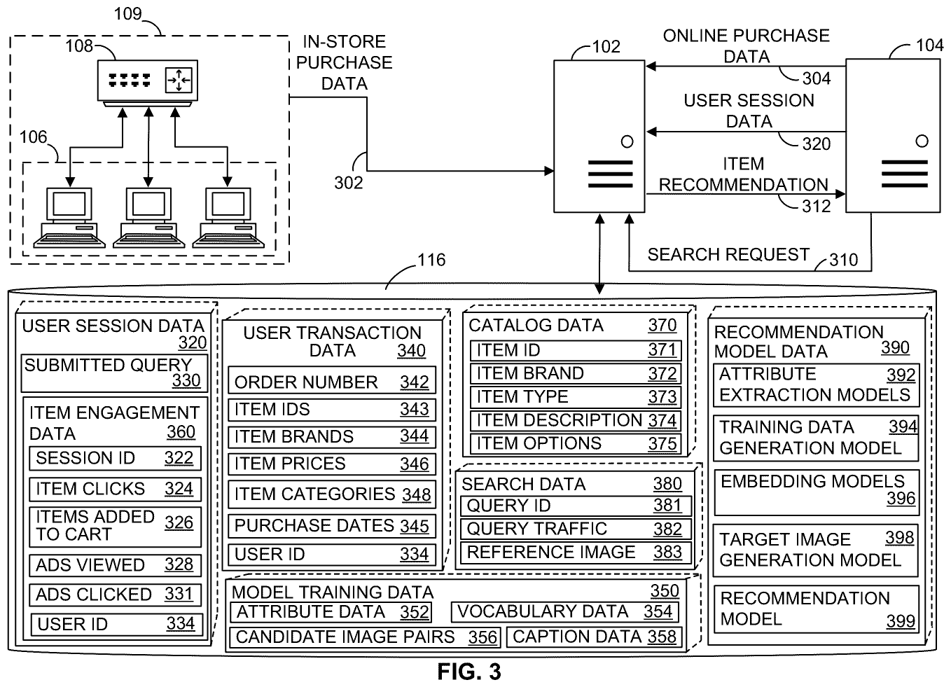

FIG. 3 is a block diagram illustrating various portions of an item recommendation system, e.g. the item recommendation system shown in the network environment 100 of FIG. 1, in accordance with some embodiments of the present teaching. As indicated in FIG. 3, the item recommendation computing device 102 may receive user session data 320 from the web server 104, and store the user session data 320 in the database 116. The user session data 320 may identify, for each user (e.g., customer), data related to that user's browsing session, such as when browsing a retailer's webpage hosted by the web server 104.

In some examples, the user session data 320 may include item engagement data 360 and/or submitted query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.).

The submitted query data 330 may identify one or more searches conducted by a user during a browsing session (e.g., a current browsing session). For example, the item recommendation computing device 102 may receive a search request 310 from the web server 104, where the search request 310 may be associated with a query that identifies a reference image representing a reference product and includes one or more search terms provided by the user regarding the reference product. The item recommendation computing device 102 may store the search terms and the reference image, as provided by the user as submitted query data 330.

The item recommendation computing device 102 may also receive online purchase data 304 from the web server 104, which identifies and characterizes one or more online purchases, such as purchases made by the user and other users via a retailer's website hosted by the web server 104. The item recommendation computing device 102 may also receive in-store purchase data 302 from the store 109, which identifies and characterizes one or more in-store purchases. In some embodiments, the in-store purchase data 302 may also indicate availability of items in the store 109, and/or user IDs that have selected the store 109 as a default store for picking up online orders.

The item recommendation computing device 102 may parse the in-store purchase data 302 and the online purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item categories 348 identifying a category of each item purchased, a purchase date 345 identifying the purchase date of the purchase order, and user ID 334 for the user making the corresponding purchase.

The database 116 may further store catalog data 370, which may identify one or more features or attributes of a plurality of items, such as a portion of or all items a retailer carries. The catalog data 370 may identify, for each of the plurality of items, an item ID 371 (e.g., an SKU number), item brand 372, item type 373 (e.g., a product type like grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store search data 380, which may identify one or more features of a plurality of queries submitted by users on the website. The search data 380 may include, for each of the plurality of queries, a query ID 381 identifying a query previously submitted by users, query traffic data 382 identifying how many times the query has been submitted or how many clicks the query has received, and reference image data identifying reference images associated with some previously submitted queries.

The database 116 may also store model training data 350, which may identify various data generated for training a model to be used for item recommendation on the website. The model training data 350 may include: attribute data 352 identifying relevant attributes extracted from e.g. item title and item description, vocabulary data 354 identifying vocabularies generated for category specific jargons and conversational friendly keywords (where different vocabularies may be mapped to each other), candidate image pairs 356 including image pairs each including a reference image and a corresponding target image, and caption data 358 identifying captions generated for the candidate image pairs 356, where each caption is generated for a candidate image pair based on a relationship between the reference image and the target image in the candidate image pair.

The database 116 may also store recommendation model data 390 identifying and characterizing one or more models (e.g. machine learning models) and related data. For example, the recommendation model data 390 may include one or more attribute extraction models 392, a training data generation model 394, one or more embedding models 396, a target image generation model 398, and a recommendation model 399. Each attribute extraction model 392 may be used to extract one or more attributes from title and description of an item. For example, each attribute extraction model 392 may be a machine learning model trained specific to a category, with labelled category specific jargons for identifying the attributes specific to that category. The extracted attributes may be stored as the attribute data 352 in the database 116.

The training data generation model 394 may be used to generate training data for training a machine learning model, e.g. the one or more attribute extraction models 392, the one or more embedding models 396, the target image generation model 398, and/or the recommendation model 399. In some embodiments, the training data generation model 394 may be used to generate the vocabulary data 354 based on the attribute data 352, to generate a mapping between domain specific jargons and user friendly words. This allows the system to handle all queries, regardless whether a query includes domain specific jargons or user friendly words.

In some embodiments, the training data generation model 394 may be used to generate the candidate image pairs 356 each representing a pair of products, e.g. based on the attribute data 352 of different products. In some examples, for each generated pair of products, they cannot be too similar or too different. For example, each generated pair of products must have at least one same attribute between them and at least one different attribute between them.

In some embodiments, the training data generation model 394 may also be used to generate the caption data 358, including captions generated for the candidate image pairs 356. In some examples, the captions are generated automatically based on the attribute data 352, the vocabulary data 354 and the candidate image pairs 356, without any human input. In various examples, a caption may be: a direct caption directly referring to a required attribute of the target image, a negative caption specifying an undesired attribute of the reference image, or a relative caption referring to a relative difference between the reference image and the target image.

The one or more embedding models 396 may be used to generate embeddings for text or image data. For example, the one or more embedding models 396 may include an embedding model used by a text encoder to compute a text embedding based on a textual query. In another example, the one or more embedding models 396 may include another embedding model used by an image encoder to compute an image embedding based on an image, e.g. a reference image or a target image. In some examples, the text embedding and the image embedding may be placed in a same embedding space, e.g. a semantic space.

In some embodiments, the target image generation model 398 may be used to generate or identify a target image, given a reference image and a textual query. In some embodiments, the target image generation model 398 is trained based on the model training data 350 during a training stage, and used during an inference stage to enable conversational shopping. The target image represents a target product that can be recommended to the user in response to the search request 310.

In some examples, the recommendation model 399 may be used to determine the final item recommendation, e.g. based on the target products identified by the target image generation model 398. For example, when there are multiple target products regarding one search request, the recommendation model 399 may be used to rank the target products, filter the target products, to generate a final item or a list of ranked items to be displayed to the user. In some embodiments, one or more of the attribute extraction model 392, the training data generation model 394, the one or more embedding models 396, the target image generation model 398, and the recommendation model 399 are machine learning models (e.g. deep learning models, neural networks) that are pre-trained before being stored in the database 116.

In some examples, the item recommendation computing device 102 receives (e.g., in real-time) a search request 310 associated with a reference image and a query referring to the reference image, from the web server 104. In response, the item recommendation computing device 102 generates item recommendation 312 identifying recommended items in response to the query, and transmits the item recommendation 312 to the web server 104. In some examples, the reference image may be associated with an anchor item interacted by or selected by a user; and the query identifies one or more features desired to be different from the anchor item. In response, the item recommendation computing device 102 generates recommended items that are close to the anchor item and include the desired features identified by the query. The desired features may be expressed in the query, in direct, negative, or relative manners.

In some embodiments, the item recommendation computing device 102 may assign one or more of the above described operations to a different processing unit or virtual machine hosted by the one or more processing devices 120. Further, the item recommendation computing device 102 may obtain the outputs of the these assigned operations from the processing units, and generate the item recommendation 312 based on the outputs.

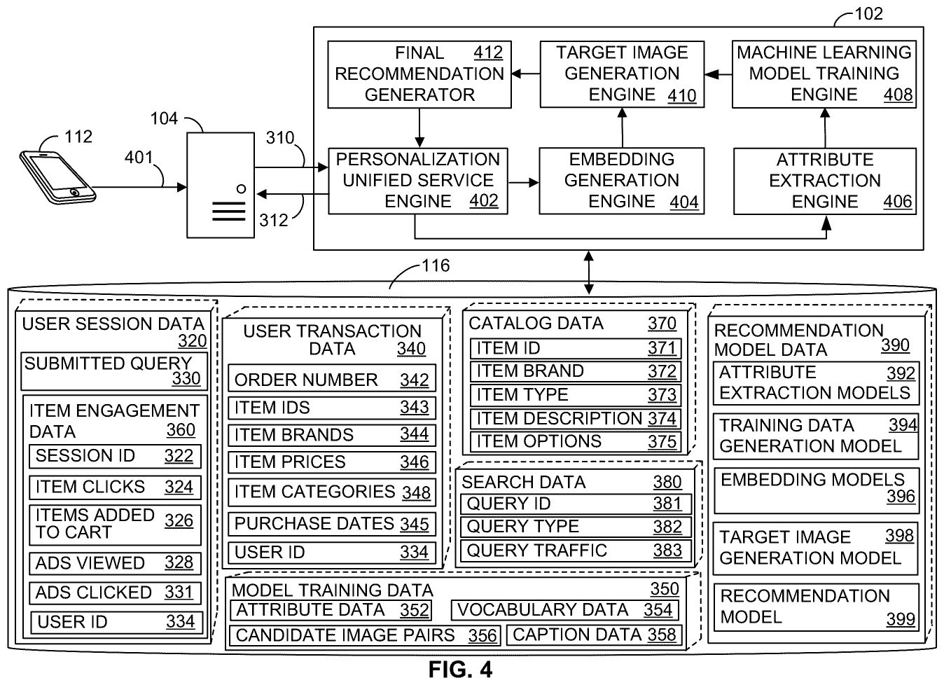

FIG. 4 is a block diagram illustrating a more detailed view of an item recommendation computing device, e.g. the item recommendation computing device 102 in FIG. 1, in accordance with some embodiments of the present teaching. As shown in FIG. 4, the item recommendation computing device 102 includes a personalization unified service engine 402, an embedding generation engine 404, an attribute extraction engine 406, a machine learning model training engine 408, a target image generation engine 410, and a final recommendation generator 412. In some examples, one or more of the personalization unified service engine 402, the embedding generation engine 404, the attribute extraction engine 406, the machine learning model training engine 408, the target image generation engine 410, and the final recommendation generator 412 are implemented in hardware. In some examples, one or more of the personalization unified service engine 402, the embedding generation engine 404, the attribute extraction engine 406, the machine learning model training engine 408, the target image generation engine 410, and the final recommendation generator 412 are implemented as an executable program maintained in a tangible, non-transitory memory, such as instruction memory 207 of FIG. 2, which may be executed by one or processors, such as the processor 201 of FIG. 2.

For example, the personalization unified service engine 402 may obtain from the web server 104 a search request 310 as a message 401 is sent from the user device 112 to the web server 104, and may execute model(s) included in the recommendation model data 390. The message 401 sent by the user using the user device 112 may indicate a search query and a reference image representing a reference item, where the search query identifies features not available in or different from the reference item. The search request 310 may either include information about the reference item, or indicate the reference item in the user session data 320. In some embodiments, the search request 310 is to seek one or more recommended items to be displayed on a webpage, e.g. a home page or a product description page, or in an interface of a chatbot.

In some embodiments, the search query may include texts input by the user in a search bar. In some embodiments, the search query may include texts converted from an utterance input by the user. In some embodiments, the reference image is selected by the user from item images displayed to the user on the website. In some embodiments, the reference image is uploaded by the user to the website.

In this example, the web server 104 transmits a search request 310 to the item recommendation computing device 102. The search request 310 may include a request for item recommendations for presentation to a particular user using the user device 112. In some examples, the search request 310 further identifies a user (e.g., customer) for whom the item recommendations are requested at the web server 104. The personalization unified service engine 402 receives the search request 310. In some embodiments, the personalization unified service engine 402 receives and parses the user session data 320 (e.g., user session data associated with a current user session of the user in real-time). During an inference stage of the system, the personalization unified service engine 402 may provide to the embedding generation engine 404 the user session data 320 and/or other data, which may include the user transaction data 340, the search data 380, and/or the model training data 350 extracted from the database 116.

In some embodiments, the embedding generation engine 404 can obtain or collect various data with respect to the search request 310, either from the personalization unified service engine 402 or directly from the database 116. In some embodiments, the embedding generation engine 404 can determine the reference image representing the reference product, which is associated with the query indicated by the search request 310. In some embodiments, the embedding generation engine 404 can compute a text embedding in an embedding space based on the textual query, e.g. using one of the embedding models 396 in the database 116; and compute an image embedding in the same embedding space based on the reference image, e.g. using one of the embedding models 396 in the database 116. As the user is seeking a target product associated with both the textual query and the reference image, the embedding generation engine 404 generates both the text embedding and the image embedding in a same embedding space, e.g. a semantic space including text and image embeddings. The embedding generation engine 404 may send the generated embeddings to the target image generation engine 410 for target image generation.

The target image generation engine 410 may combine the text embedding and the image embedding generated based on the search request 310, using a machine learning model, e.g. the target image generation model 398 in the database 116. The text embedding and the image embedding may be combined with some adaptive weights determined based on a training process of the target image generation model 398 in the database 116. For example, the target image generation engine 410 may generate a combined embedding representing an aggregate of the textual query and the reference image in the semantic space, based on the adaptive weights. The target image generation engine 410 may determine, in the semantic space, a target image based on the combined embedding using a machine learning model, e.g. the target image generation model 398. For example, the target image may be an image whose embedding is closest to the combined embedding in the semantic space. The target image may represent a target product matching the user's intent associated with the search request 310. The target image generation engine 410 may then send the target image to the final recommendation generator 412. In some embodiments, the target image generation engine 410 may generate multiple target images representing multiple target products matching the user's intent associated with the search request 310, and send all of these target images to the final recommendation generator 412.

The final recommendation generator 412 in this example may obtain the target images representing target products from the target image generation engine 410, and generate a final recommended item or a ranked list of recommended items in response to the query. In some embodiments, the ranked list of recommended items may be generated based on a ranking model, e.g. the recommendation model 399 in the database 116. In some embodiments, the final recommendation generator 412 may generate the item recommendation 312 based on the final recommended item or the ranked list of recommended items. In some embodiments, the item recommendation 312 include the ranked list of recommended items and position information for each recommended item. In some examples, each of the ranked list of recommended items has a corresponding rank and is recommended to be displayed at a corresponding position in a webpage based on its corresponding rank. For example, a higher ranked item may be recommended to be displayed at a more popular position in the webpage. The final recommendation generator 412 may send the item recommendation 312 to the personalization unified service engine 402.

The personalization unified service engine 402 may receive the item recommendation 312 from the final recommendation generator 412 in a data format (e.g., message) acceptable by the web server 104. The personalization unified service engine 402 transmits the item recommendation 312 to web server 104. The web server 104 may then update or generate item recommendation for presentation to the user via the user device 112 based on the item recommendation 312. For example, the item recommendation may be displayed on a webpage showing a product description of an anchor item to the user, on a webpage showing search results in response to a query to the user, on a webpage showing a shopping cart including the anchor item to the user, on a webpage showing an order of the anchor item placed by the user, and/or on a homepage of a website. In some embodiments, the item recommendation may be displayed via an interface of a chatbot, as a response to the user's query entered via the interface. The query and response form a conversation between the user and the chatbot, to enable a conversational shopping journey for the user on the website.

During a training stage of the system, the personalization unified service engine 402 may provide to the attribute extraction engine 406 the user session data 320 and/or other data, which may include the user transaction data 340, the search data 380, and/or previous model training data 350 extracted from the database 116. The attribute extraction engine 406 can extract attributes from item title and item descriptions, e.g. based on the one or more attribute extraction models 392 in the database 116. In some embodiments, for each item used for training, the attribute extraction engine 406 may first determine its category; determine an attribute extraction model pre-trained specific to the category; and then extract the attributes of the item using the determined attribute extraction model, e.g. based on the item's title, description, image, etc. In some embodiments, the attribute extraction engine 406 may use some regular expression based rules to extract the attributes. The attribute extraction engine 406 may store the extracted attributes as the attribute data 352 in the database 116. The attribute extraction engine 406 may send the extracted attributes to the machine learning model training engine 408 for training a machine learning model for conversational shopping.

In some embodiments, the machine learning model training engine 408 may use the training data generation model 394 in the database 116 to generate labelled training data for training the machine learning model for conversational shopping, based on the extracted attributes. In some embodiments, the training data generation model 394 may include multiple sub-models.

In some examples, the extracted attributes from the attribute extraction engine 406 may include complicated category specific jargons that a user is unlikely to use in a search query or during a conversation with a chatbot. As such, the machine learning model training engine 408 can generate the vocabulary data 354 to map these category specific jargons to user friendly terms.

In some examples, the machine learning model training engine 408 may generate the candidate image pairs 356 for training the machine learning model, e.g. based on the attribute data 352 and the vocabulary data 354. Each candidate image pair includes a reference image of a reference product and a target image of a target product. For each candidate image pair, the machine learning model training engine 408 may further generate one or more captions to describe a relationship between the reference image and the target image, or a relationship between the reference product and the target product. Each caption may be expressed in a direct manner, a negative manner, or a relative manner. In some embodiments, each caption identifies a way in the semantic space to go to an embedding of the target image from an embedding of the reference image. The machine learning model training engine 408 may store the generated captions in the caption data 358 in the database 116. Based on the candidate image pairs 356 labelled with the generated 358, the machine learning model training engine 408 may train the machine learning model, e.g. the target image generation model 398, and provide the trained machine learning model to the target image generation engine 410 for target image generation during an inference stage. The trained machine learning model may also be stored in the database 116, e.g. as the one or more embedding models 396 and/or the target image generation model 398 in the database 116.

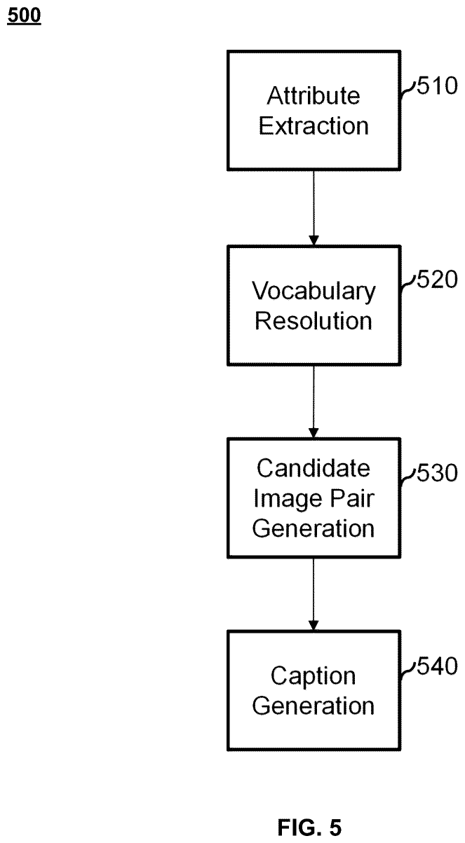

FIG. 5 illustrates an exemplary process 500 to generate training data for conversational shopping, in accordance with some embodiments of the present teaching. In some embodiments, the process 500 may be carried out by one or more computing devices, such as the item recommendation computing device 102 and/or the cloud-based engine 121 of FIG. 1.

As shown in FIG. 5, the process 500 starts from operation 510 to perform attribute extraction. In some examples, the operation 510 may be performed by the attribute extraction engine 406 in the item recommendation computing device 102. Many item attributes are present in catalog data, e.g. the catalog data 370 in the database 116. But those item attributes are often noisy and not exhaustive enough to cater customer needs. Here, at the operation 510, the system utilizes item title and item description to extract relevant attributes for an item. To extract attributes from an item in a category, the system can use a pretrained model specific to that category, with labelled category specific jargon for identifying the attributes. In absence of a pretrained model, the system can also use regular expression based rules to extract the attributes from title and description, based on patterns in the title and description.

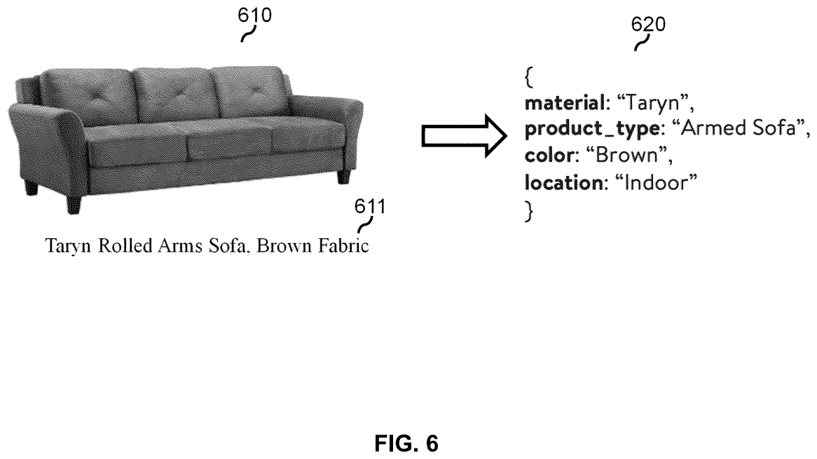

FIG. 6 illustrates an example of attribute extraction from an item title, in accordance with some embodiments of the present teaching. An item title may be used to describe an item for any category, any product type, any material, any color, any location, etc. For example, as shown in FIG. 6, an item 610 has a title 611 of “Taryn Rolled Arms Sofa, Brown Fabric.” The system can extract predefined attributes 620 from the title 611, e.g. at the operation 510. In this example, as the item 610 falls into a furniture category and a sofa sub-category, the system has defined four attributes: material of the item 610, product type of the item 610, color of the item 610, and location suitable for the item 610. As such, the extracted attributes 620 identify that: the material of the item 610 is “Taryn”, the product type of the item 610 is “Armed Sofa”, the color of the item 610 is “Brown”, and the location suitable for the item 610 is “Indoor”. In another example, when attributes need to be extracted from an item in a grocery category, other kinds of attributes should be extracted from that item. That is, the attribute data extracted from each item is dependent on a category and/or a sub-category including that item.

Referring back to FIG. 5, a vocabulary resolution is performed at operation 520. In some examples, the operation 520 may be performed by the machine learning model training engine 408 in the item recommendation computing device 102. The attributes extracted at the operation 510 often have complicated jargons, which users might not be familiar with. The vocabulary resolution at the operation 520 is used to convert these complicated jargons to conversational friendly keywords. In some embodiments, the system can obtain specific definitions of different jargons based on some open source information. In absence of open source information for some categories, the system can create definitions for the jargons in the categories. Based on the obtained and generated jargon definitions, the system can perform vocabulary resolution based on: removing stop words and most common words from the jargon definitions to generate filtered jargon definitions; generating a new vocabulary using unigram and bigram generated based on the filtered jargon definitions; and mapping the attributes extracted from the operation 510 to the new vocabulary that is user friendly and conversational friendly.

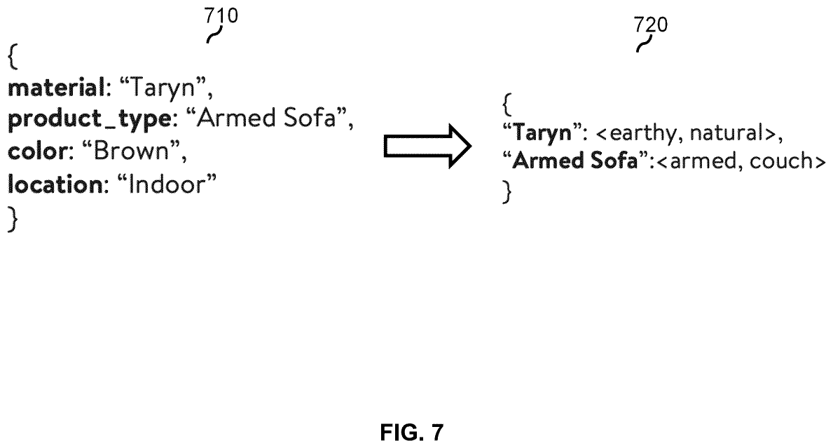

FIG. 7 illustrates an example of vocabulary resolution to map jargons to user friendly keywords, in accordance with some embodiments of the present teaching. As shown in FIG. 7, a mapping 720 is generated based on the attribute data 710 for an item, e.g. the item 610. The mapping 720 can resolve jargons, e.g. domain specific jargons like “Taryn” and “Armed Sofa” to user friendly words which represent what normally people would understand and describe these jargons. For example, “Taryn” can be mapped to “earthy” and/or “natural”; while “Armed Sofa” can be mapped to “armed” and/or “couch”. As such, even if a user does not know a jargon, and instead just enter some normal user friendly words, the system can map these user friendly words to jargons in attribute data to determine corresponding attributes and products desired by the user. For example, after a user enters “I want earthy sofa,” the system can understand that the user may like a sofa that is made of Taryn. In some embodiments, not every term in the attributes need to be converted, but only uncommon jargons are converted to common user friendly words.

Referring back to FIG. 5, candidate image pairs are generated at operation 530. In some examples, the operation 530 may be performed by the machine learning model training engine 408 in the item recommendation computing device 102. To train a machine learning model for target image generation, the system need candidate pairs of images to act as reference image and target image respectively. In some embodiments, some candidate image pairs are generated between same categories while some candidate image pairs are generated between different categories. The system may first generate candidates based on title and description similarity using Term Frequency-Inverse Document Frequency (TF-IDF) vectors. The TF-IDF based method can assign scores to words in a text to indicate how important this word is, e.g. whether the word is unique or very common, to generate TF-IDF vectors. The system may create a first TF-IDF vector for the reference product, and a second TF-IDF vector for the corresponding target product; and compute a similarity score between those two TF-IDF vectors. When the similarity score is higher than a predetermined threshold, the image pair is eligible to be a candidate image pair. If that similarity score is lower than the predetermined threshold, these two images are too drastically different such that the image pair is ineligible to be a candidate image pair. In some embodiments, other techniques like BERT (Bi-directional Encoder Representations from Transformers) embeddings may be used to compute similarity between the two images in each pair.

Further, the system can filter the generated pairs based on some conditions over previously generated attributes. For example, one condition is that: for each candidate image pair, the reference image and the target image should have at least one same attribute. Another condition may be that: for each candidate image pair, there should be at least one different attribute between the reference image and the target image. These conditions can ensure that the generated image pairs are not very different and the difference between them can be conveyed by a textual feedback or textual query.

As every image pair will need a caption for training, the system only generates captions for products which are not too similar and not too different. When two products are too similar or almost the same, no caption is needed. When two products are too different, no caption is able to describe all differences between them to effectively connect them in the embedding space. As such, the eligible image pairs (with similarity scores higher than a threshold) may be further filtered based on two conditions that: out of the extracted attributes, there should be at least one same attribute between the images (or items) in each pair, and there should be at least one different attribute between them as well.

At operation 540, caption generation is performed. In some examples, the operation 540 may be performed by the machine learning model training engine 408 in the item recommendation computing device 102. To train a machine learning model for target image generation, captions need to be generated as labels for each candidate image pair. While these labels can be manually generated using a crowd of people, this kind of crowd labelling is very slow and costly, and not scalable. In some embodiments, for image pairs representing items in a same category, the system can generate captions based on various templates, which can mimic users' conversational behaviors. The templates may include: direct caption template, relative caption templates, and negative caption template.

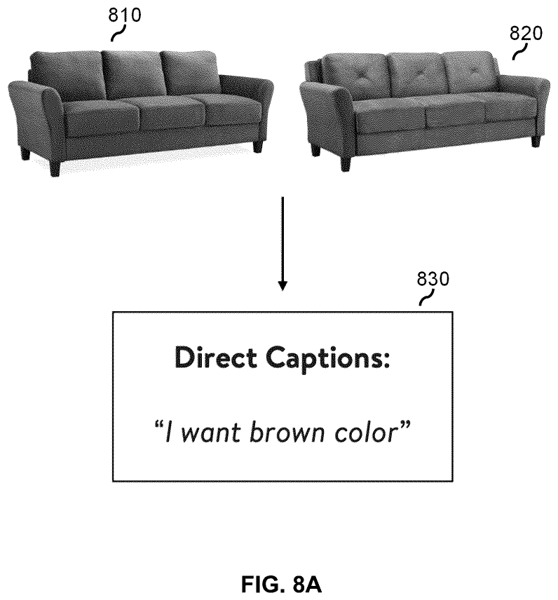

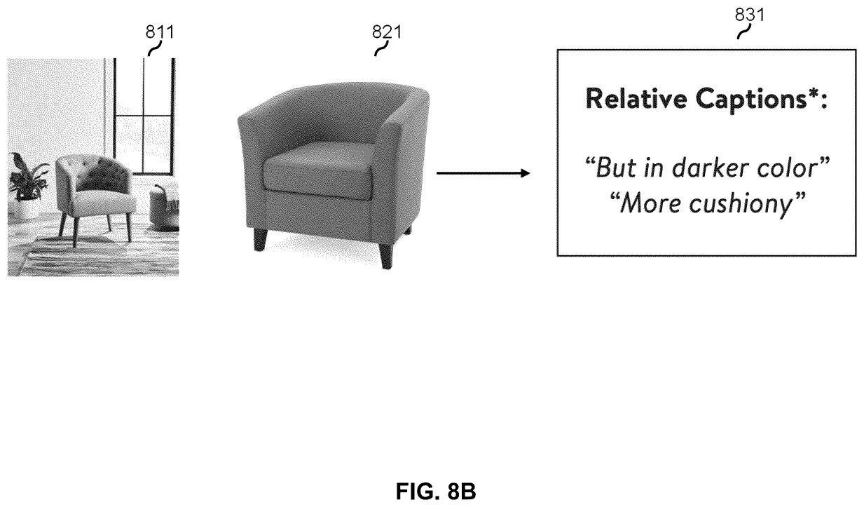

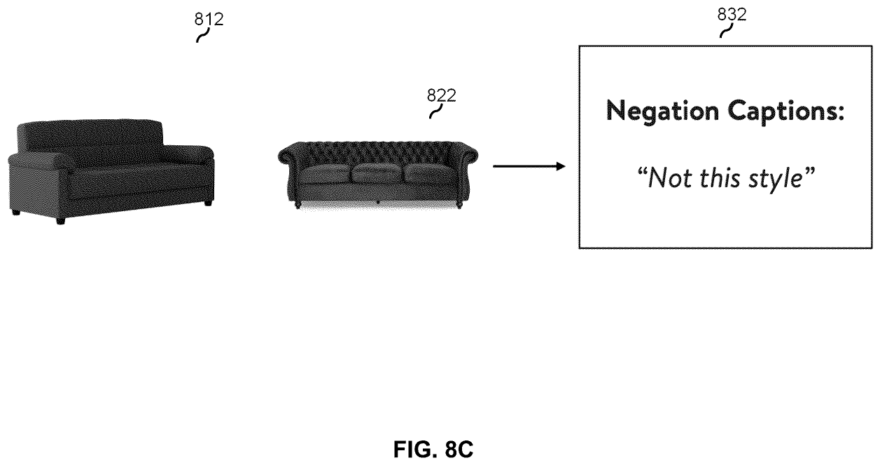

A direct caption template may be used to generate a direct caption that directly refers to a desired or required attribute of the target image which is different from the reference image. FIG. 8A illustrates an exemplary caption generation process to generate a direct caption for a first candidate image pair, in accordance with some embodiments of the present teaching. As shown in FIG. 8A, for an image pair including a reference image 810 and a target image 820, a direct caption 830 may be generated to recite: “I want brown color.” This direct caption 830 directly identifies an attribute “brown color” that is desired or required in the target image 820, but not in the reference image 810.

A relative caption template may be used to generate a relative caption that, rather than referring to desired or required attributes directly, uses relative terms to describe a difference regarding some attribute between the target image and the reference image. In some embodiments, the relative captions may be generated based on a mapping or model defining relativeness between attributes. For example, the model can define that black is a color darker than brown, and brown is a color darker than blue. FIG. 8B illustrates another exemplary caption generation process to generate a relative caption for a second candidate image pair, in accordance with some embodiments of the present teaching. As shown in FIG. 8B, for an image pair including a reference image 811 and a target image 821, relative captions 831 may include: “But in darker color;” and “More cushiony.” Each of these relative captions 831 identifies a relativeness (e.g. darker, more) of an attribute (e.g. color, cushiony) of the target image 821 compared to the attribute of the reference image 811.

A negative caption template may be used to generate a negative or negation caption that specifies which attribute in the reference image is undesired any more by a user in the target image, without specifying a desired or required attribute directly in the target image. FIG. 8C illustrates yet another exemplary caption generation process to generate a negative caption for a third candidate image pair, in accordance with some embodiments of the present teaching. As shown in FIG. 8C, for an image pair including a reference image 812 and a target image 822, a negative caption 832 may recite: “Not this style.” This negative caption 832 identifies an attribute “this style” that is in the reference image 812, but is not desired or included in the target image 822.

These captions generated based on various templates can be used as labels to train a machine learning model for conversational shopping. A user may use normal conversational text, rather than sticking exactly to these templates. Since the machine learning model is trained based on natural language data, users' normal conversational text inputs can be understood by the trained model as an effective caption during conversational shopping. The trained machine learning model can thus enable a conversation with a chatbot or artificial intelligence (AI) for online shopping. In this way, the model can understand users' intent and provide items with different or changed attributes accordingly.

In addition, for some categories like furniture, a shopper often wants to look at different furniture items together to understand whether they look good together or not. For example, a user may want a table matching to a couch. In this case, the system can compute a compatibility to determine what kind of table might look good with a given kind of sofa.

In some embodiments, for each image pair representing items in different categories, the system can generate a compatibility score representing a degree of compatibility between the two images in the image pair. In some embodiments, the compatibility score is F1+F2, where F1 is a similarity score between attributes of the two items and F2 is a bought-also-bought (BAB) score of the two items, and “+” in this computation may represent any combination of F1 and F2, including summation, weighted summation, multiplication, weighted multiplication, or any other linear or non-linear combinations. The F1 score can represent whether the two items or images share a same or similar attribute, e.g. color, material, outdoor/indoor style, etc., to determine whether they look in harmony with each other. The F2 score can be computed based on customers' feedback regarding how often these two items were bought together, where a high F2 score for items A and B means the two items are often bought together by a same user. A combination of F1 and F2 scores can generate a compatibility score which represents how well a pair of items will go together.

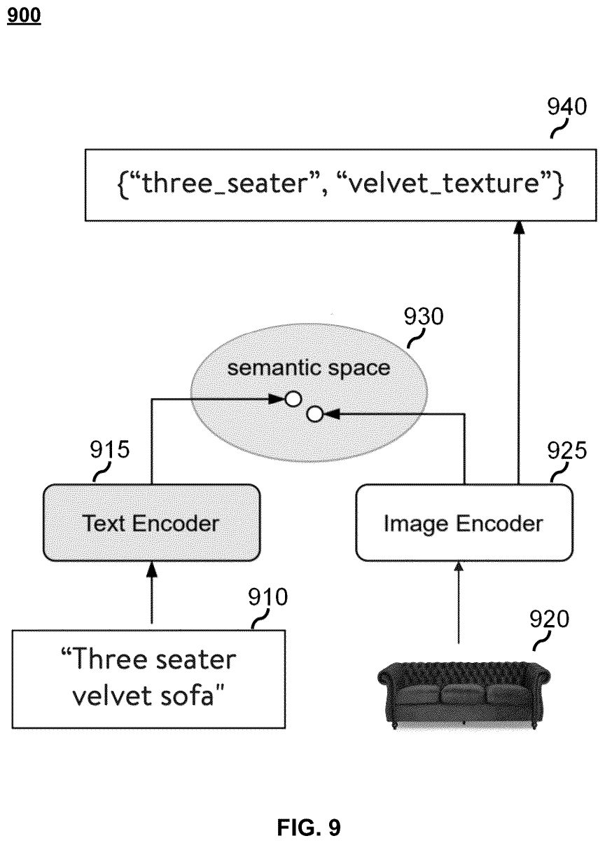

FIG. 9 illustrates an exemplary process 900 for extracting attributes based on text and image data of some item, in accordance with some embodiments of the present teaching. In some examples, this exemplary process 900 may be performed by the attribute extraction engine 406 in the item recommendation computing device 102. As shown in FIG. 9, given a title 910 of a product, and given an image 920 of the same product, the system may extract attributes from the title 910, a description of the image 920 and/or the image 920 itself. In some examples, a text encoder 915, which may be part of the attribute extraction engine 406, can extract from the title 910 attributes represented as an embedding in a semantic space 930. In some examples, an image encoder 925, which may be part of the attribute extraction engine 406, can extract from the image 920 attributes represented as an embedding in the semantic space 930. In some embodiments, the image encoder 925 may extract attributes from a title or description 940 of the image 920. In some embodiments, the image encoder 925 may extract attributes from the image 920 itself directly, based on an image recognition model pre-trained to recognize attributes from each image. In some embodiments, the pre-trained image recognition model is re-trained based on some category specific data to fit the category of attribute extraction, before being used for extracting attributes as shown in FIG. 9. These extracted attributes can used later for creating captions and other training data.

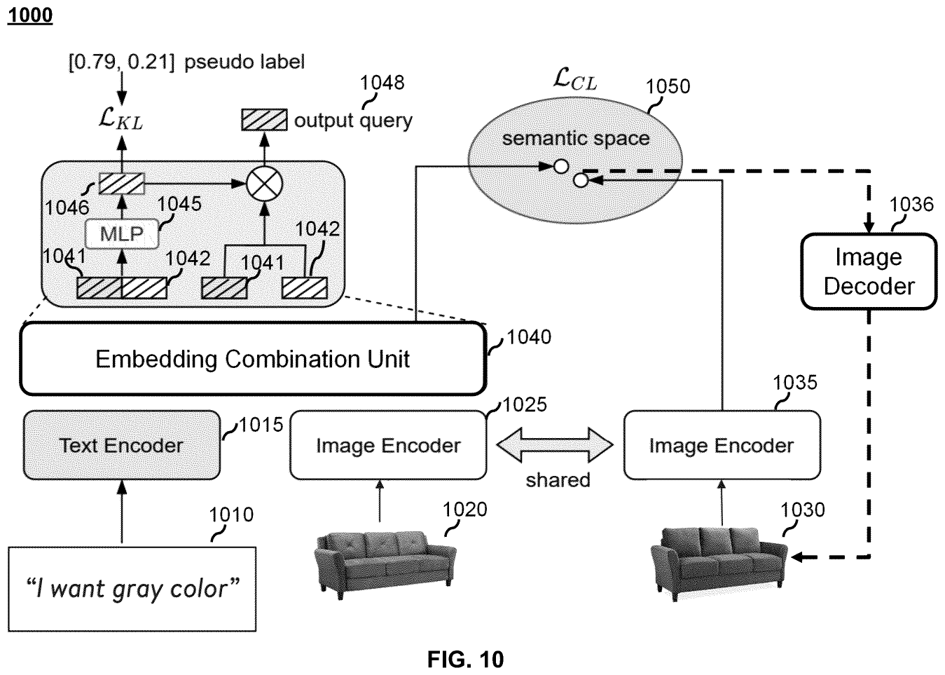

FIG. 10 illustrates an exemplary process 1000 for training a machine learning model and using the model during inference to generate a target image, in accordance with some embodiments of the present teaching. In some examples, this exemplary process 1000 may be performed by the machine learning model training engine 408 and/or the target image generation engine 410 in the item recommendation computing device 102. As shown in FIG. 10, given a caption 1010 and a reference image 1020 of a reference product, the system may generate embeddings in a same semantic space 1050. For example, a text encoder 1015 can compute a text embedding 1041 in the semantic space 1050 based on the caption 1010; while an image encoder 1025 can compute an image embedding 1042 in the semantic space 1050 based on the reference image 1020. Each of the text embedding 1041 and the image embedding 1042 may be an N-dimensional vector, while the semantic space 1050 may be an N-dimensional space.

During a training stage of the system, the caption 1010 is generated as a label by the system based on some template for a candidate image pair, where the candidate image pair include the reference image 1020 and a target image 1030. An embedding combination unit 1040 may combine the text embedding 1041 of the caption 1010 and the image embedding 1042 of the reference image 1020, to generate an output query 1048 that is a combined embedding in the semantic space 1050. The purpose of the training stage is determine optimal parameters in the machine learning model to function well during a later inference stage.

In some embodiments, the embedding combination unit 1040 combines together two modalities, the text modality corresponding to the text embedding 1041 and the image modality corresponding to the image embedding 1042, to generate a hybrid-modality query with adaptive weighting. For example, the text embedding 1041 and the image embedding 1042 can be combined based on a multilayer perceptron (MLP) 1045. In some examples, the text embedding 1041 and the image embedding 1042 are concatenated together to form a concatenated vector having a length equal to a sum of lengths of the vectors of the text embedding 1041 and the image embedding 1042. Based on the MLP 1045, the concatenated vector is multiplied by a weight matrix to generate a new embedding 1046, which represents a weighted combination of the text embedding 1041 and the image embedding 1042. During training, different weights in the weight matrix are tested to find an optimal set of weights that can generate an optimal new embedding 1046 that minimizes a loss function, e.g. Kullback-Leibler (KL) divergence loss represented by [symbol] _{KL}. In some embodiments, the KL loss function is computed based on a pseudo label whose values in FIG. 10 are merely shown for exemplary and illustrative purposes without limiting the scope of the present disclosure. In some embodiments, in addition to the weights, there are many other enable parameters and hyperparameters in different layers of the machine learning model such that once the model is trained, a combination of all these parameters and weights is selected to minimize the KL loss function.

In addition, the new embedding 1046 is multiplied by the text embedding 1041 and the image embedding 1042 to test a similarity of the new embedding 1046 to the text embedding 1041 and the image embedding 1042, respectively. The output query 1048 is a combined embedding in the semantic space 1050 that incorporates the text embedding 1041, the image embedding 1042 and the new embedding 1046 that can minimize the KL loss function. During training, an image encoder 1035 can compute a target image embedding in the semantic space 1050 based on the target image 1030. A contrastive loss (CL) function represented by [symbol] _{CL} may be computed based on the combined embedding of the output query 1048 and the target image embedding, to determine how similar they are to each other. During training, a combination of all hyperparameters and weights in the machine learning model is selected and learned to minimize the CL loss function. As such, after training, all hyperparameters and weights in the machine learning model will work together to ensure that for any caption corresponding to an image pair, the machine learning model can generate (a) an output query as a combined embedding based on the caption and the reference image of the image pair and (b) a target image embedding of the target image of the image pair, where the combined embedding is as close as possible to the target image embedding. This means that the difference between the image embeddings of the two images in each pair can be described by a corresponding caption. This will ensure that during an inference stage of the system, given a caption and a reference image, the trained machine learning model can help to find a suitable target image that is close to the combined embedding of the caption and the reference image in the semantic space 1050.

In some embodiments, the machine learning model can be re-trained periodically or upon an event. For example, the machine learning model may be re-trained to increase category size, or when a category is established, or when a user feedback data indicates that the current model does not provide good result to the users.

During an inference stage of the system, the caption 1010 is obtained from a textual query submitted by a user, via text or utterance input; while the reference image 1020 is selected, identified or uploaded by the user e.g. via an interface of a chatbot. Different from the training stage, the target image 1030 is not given but needs to be found in the inference stage. The purpose of the inference stage is to find or determine a target image that can best match a combination of the caption 1010 and the reference image 1020. The text encoder 1015 and the image encoder 1025 in the inference stage work the same as those in the training stage, to generate the text embedding 1041 and the image embedding 1042, respectively. The embedding combination unit 1040 in the inference stage work similarly to that in the training stage, to generate an output query 1048, but based on parameters and weights that are already determined and optimized during the training stage. Then, the system can determine, in the semantic space 1050, a target embedding that is closest to the combined embedding corresponding to the output query 1048, and use an image decoder 1036 to determine a target image, which should be the target image 1030 if decoded correctly in this case, based on the target embedding. In general, for any caption or textual query referring to a reference image, the trained machine learning model can combine the text embedding of the textual query and the image embedding of the reference image, to generate a combined embedding in the semantic space 1050; determine a target embedding closest to the combined embedding in the semantic space 1050 among all image embeddings pre-stored in a database, e.g. the database 116, for the website; and determine a target image corresponding to the target embedding.

In some embodiments, the image encoder 1025 and the image encoder 1035 can share a same architecture or unit in the item recommendation computing device 102. In various embodiments, one or more of the text encoder 1015, the image encoder 1025, the image encoder 1035, the image decoder 1036, the embedding combination unit 1040 may be part of the machine learning model.

In some embodiments, the text encoder 1015 may be able to understand any textual query input by a user, e.g. based on a natural language processing model. That is, although a caption 1010 of “I want gray color” is generated as a label for training, the trained model can process any input query as a variant of a given caption. For example, whether the user inputs “I like gray color,” “I prefer the color to be gray,” “gray color please,” or “gray is better,” the text encoder 1015 can recognize this variant and determine that gray color is a desired attribute by the user. The model can understand the user's intent, while the user can express the intent in any manner.

In some embodiments, the machine learning model is trained using image groups, where each group includes one reference image and multiple target images, corresponding to a given caption label. In this manner, the trained machine learning model can identify a group or a ranked list of target images, given a textual query referring to a reference image during the inference stage. After providing the list of target images to the user, the user's action (e.g. selection, click, added to cart, etc.) on one or more of the provided target images can be used as feedback data to update the parameters and/or weights in the machine learning model.

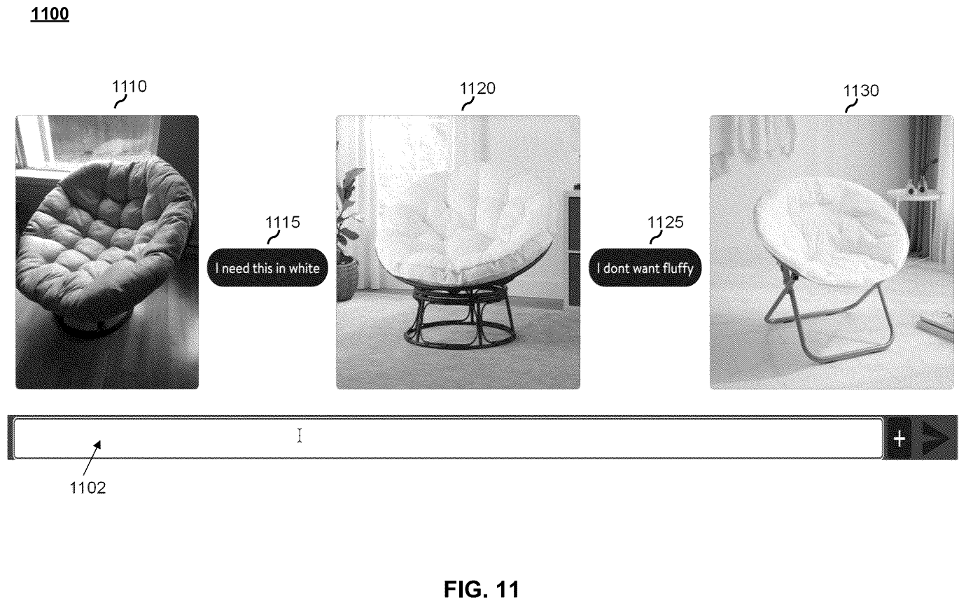

FIG. 11 illustrates an exemplary process 1100 for automatic conversational shopping based on an item recommendation system, in accordance with some embodiments of the present teaching. As shown in FIG. 11, after a user observes a first image 1110 representing a first product via an interface of a chatbot, the user may enter a textual query 1115 reciting “I need this in white,” e.g. via a search bar 1102 of the chatbot. The system can utilize a machine learning model, e.g. one or more models as previously described regarding FIGS. 1-10, to determine and provide a second image 1120 as a target image, based on the textual query 1115 referring to the first image 1110 as a reference image. The second image 1120 in this example is similar to the first image 1110 except that the product in the second image 1120 is in white color.

After observing the second image 1120, the user may enter another textual query 1125 reciting “I don't want fluffy,” e.g. via the search bar 1102 of the chatbot. The system can again utilize the machine learning model to determine and provide a third image 1130 as a new target image, based on the textual query 1125 referring to the second image 1120 as a new reference image. The third image 1130 in this example is similar to the second image 1120 except that the product in the third image 1130 is not fluffy.

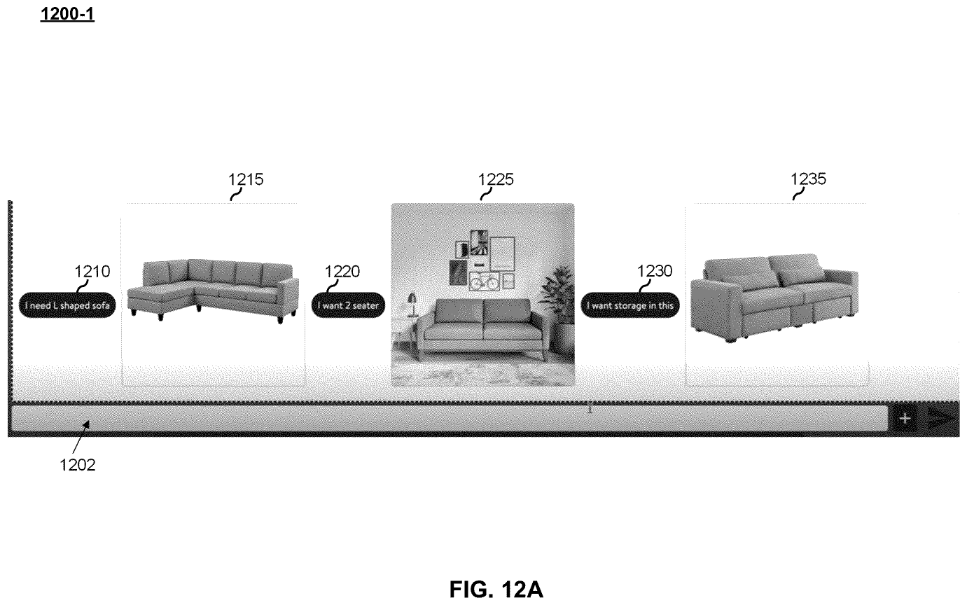

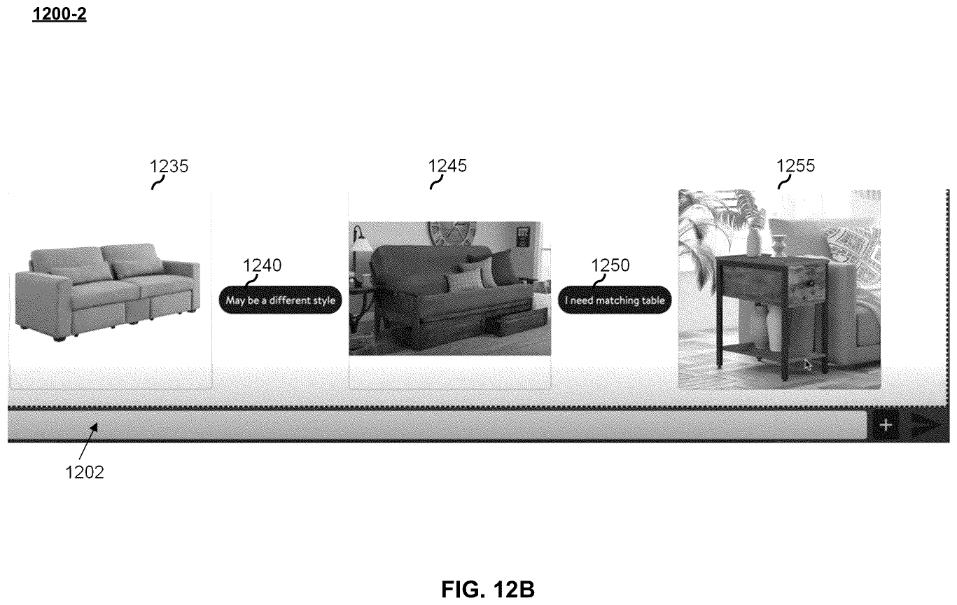

FIG. 12A and FIG. 12B illustrate another exemplary process 1200 (including 1200-1 in FIG. 12A and 1200-2 in FIG. 12B) for automatic conversational shopping based on an item recommendation system, in accordance with some embodiments of the present teaching. As shown in FIG. 12A, a user may submit a first textual query 1210 reciting “I need L shaped sofa” via a search bar 1202 of a chatbot. The system can search the database to find a matching sofa and provide its image 1215 via an interface of the chatbot. Then, the user may enter a second textual query 1220 reciting “I want 2 seater,” e.g. via the search bar 1202. The system can then utilize a machine learning model, e.g. one or more models as previously described regarding FIGS. 1-10, to determine and provide a target image 1225, based on the textual query 1220 referring to the image 1215 as a reference image. The target image 1225 in this example is similar to the image 1215 but the sofa in the target image 1225 has two seaters as desired by the textual query 1220.

After observing the target image 1225, the user may enter another textual query 1230 reciting “I want storage in this,” e.g. via the search bar 1202. The system can again utilize the machine learning model to determine and provide another target image 1235, based on the textual query 1230 referring to the image 1225 as a new reference image. The target image 1235 in this example is similar to the image 1225 except that the sofa in the target image 1235 has storage.

The process 1200 continues in FIG. 12B, where after observing the image 1235, the user may enter another textual query 1240 reciting “Maybe a different style,” e.g. via the search bar 1202. The system can again utilize the machine learning model to determine and provide another target image 1245, based on the textual query 1240 referring to the image 1235 as a new reference image. The target image 1245 in this example is similar to the image 1235 (both showing two-seater sofa with storage) but the sofa in the target image 1245 has a different style compared to the sofa in the image 1235.

Then, the user may request an item in a different category or sub-category. For example, after observing the image 1245, the user may enter another textual query 1250 reciting “I need matching table,” e.g. via the search bar 1202. The system can utilize the machine learning model to determine and provide a target image 1255, based on the textual query 1250 referring to the image 1245 as a new reference image. In this case, the target image 1255 shows a requested product, a table that can match (e.g. in terms of size, color, style, etc.) a sofa in the reference image 1245.

In this manner, the user can directly observe whether a table can go well with a given sofa, or in general whether one product can go well with another product, during a conversational shopping, even via online chatbot or website without human assistance. That is, the disclosed system enables a user to view a bunch of items together see how they look in the complete view, e.g. multiple furniture items inside a room, during an online shopping journey. The user can interact with an AI or chatbot, by giving feedback on an existing product or already displayed product, to find a desired product or multiple desired products in harmony with each other. This can bridge the gap between offline shopping and online shopping, such that a customer can tell a chatbot online, just like telling a human agent offline, e.g. “I want something similar to this but less fluffy or a different color,” and obtain a desired product directly online.

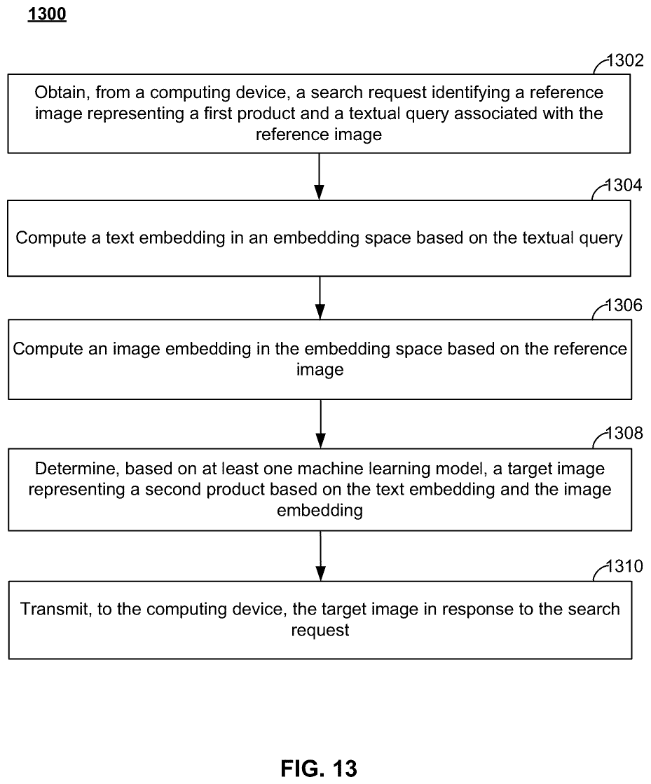

FIG. 13 is a flowchart illustrating an exemplary method 1300 for providing item recommendation to enable automatic conversational shopping based on machine learning, in accordance with some embodiments of the present teaching. In some embodiments, the method 1300 can be carried out by one or more computing devices, such as the item recommendation computing device 102 and/or the cloud-based engine 131 of FIG. 1. Beginning at operation 1302, a search request is obtained from a computing device, where the search request identifies a reference image representing a first product and a textual query associated with the reference image. At operation 1304, a text embedding in an embedding space is computed based on the textual query. At operation 1306, an image embedding in the embedding space is computed based on the reference image. A target image is determined at operation 1308 using at least one machine learning model based on the text embedding and the image embedding, where the target image represents a second product. At operation 1310, the target image is transmitted to the computing device in response to the search request, where the target image indicates a recommendation of the second product based on the search request.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain, from a computing device, a search request identifying a reference image representing a first product and a textual query associated with the reference image,
compute a text embedding in an embedding space based on the textual query,
compute an image embedding in the embedding space based on the reference image,
determine, based on at least one machine learning model, a target image representing a second product based on the text embedding and the image embedding, and
transmit, to the computing device, the target image in response to the search request.

2. The system of claim 1, wherein the target image is determined based on:
combining, using a machine learning model, the text embedding and the image embedding with weights pre-determined based on a training process of the machine learning model, to generate a combined embedding representing an aggregate of the textual query and the reference image in the embedding space; and
determining the target image based on the combined embedding using the machine learning model, wherein the target image is an image whose embedding is closest to the combined embedding in the embedding space.

3. The system of claim 2, wherein, during the training process of the machine learning model, the at least one processor is configured to:
extract item attributes from a training dataset;
convert jargons in the item attributes to generate converted item attributes;
generate candidate image pairs for training the machine learning model;
filter the candidate image pairs based on at least one condition over the converted item attributes to generate filtered image pairs;
generate captions for the filtered image pairs based on the converted item attributes; and
train, using the captions as labels, the machine learning model based on the filtered image pairs.

4. The system of claim 3, wherein the item attributes are extracted based on:
obtaining item data of a plurality of items from the training dataset; and
for each item of the plurality of items:
determining a product category of the item,
determining attributes associated with the product category,
extracting the attributes from item title, item description and item image of the item in the item data.

5. The system of claim 3, wherein the jargons are converted based on:
obtaining jargon definitions of different jargons;
removing stop words and most common words from the jargon definitions to generate filtered jargon definitions;
generating a vocabulary using unigram and bigram generated based on the filtered jargon definitions; and
mapping the jargons in the item attributes to conversational friendly keywords based on the vocabulary to generate the converted item attributes.

6. The system of claim 3, wherein the candidate image pairs are generated based on:
obtaining images of a plurality of items from the training dataset, wherein the images form a plurality of image pairs each including two images of two items; and
for each image pair including two respective images of two corresponding items:
computing a similarity score between the two respective images,
in accordance with a determination that the similarity score is higher than a predetermined threshold, add the image pair as a candidate image pair, wherein the two respective images in the candidate image pair act as reference image and target image, respectively, during the training process of the machine learning model.

7. The system of claim 3, wherein the candidate image pairs are filtered based on:
removing any candidate image pair whose two images share no common attribute; and
removing any candidate image pair whose two images have no different attribute.

8. The system of claim 3, wherein the captions are generated based on:
generating a direct caption for a first image pair including a first reference image and a first target image, wherein the direct caption directly refers to a desired or required attribute of the first target image which is different from the first reference image;
generating a relative caption for a second image pair including a second reference image and a second target image, wherein the relative caption includes a relative term to describe a difference regarding an attribute between the second target image and the second reference image; and
generating a negative caption for a third image pair including a third reference image and a third target image, wherein the negative caption specifies that an attribute in the third reference image is undesired by a user in the third target image.

9. The system of claim 1, wherein the at least one processor is configured to:
obtain, from the computing device, a new textual query after the target image is transmitted;
compute a new text embedding in the embedding space based on the new textual query;
determine the target image as a new reference image associated with the new textual query;
determine a new image embedding in the embedding space based on the target image;
determine, based on the at least one machine learning model, a new target image representing a third product based on the new text embedding and the new image embedding; and
transmit the new target image to the computing device.

10. A computer-implemented method, comprising:
obtaining, from a computing device, a search request identifying a reference image representing a first product and a textual query associated with the reference image;
computing a text embedding in an embedding space based on the textual query;
computing an image embedding in the embedding space based on the reference image;
determining, based on at least one machine learning model, a target image representing a second product based on the text embedding and the image embedding; and
transmitting, to the computing device, the target image in response to the search request.

11. The computer-implemented method of claim 10, wherein determining the target image comprises:
combining, using a machine learning model, the text embedding and the image embedding with weights pre-determined based on a training process of the machine learning model, to generate a combined embedding representing an aggregate of the textual query and the reference image in the embedding space; and
determining the target image based on the combined embedding using the machine learning model, wherein the target image is an image whose embedding is closest to the combined embedding in the embedding space.

12. The computer-implemented method of claim 11, during the training process of the machine learning model, further comprising:
extracting item attributes from a training dataset;
converting jargons in the item attributes to generate converted item attributes;
generating candidate image pairs for training the machine learning model;
filtering the candidate image pairs based on at least one condition over the converted item attributes to generate filtered image pairs;
generating captions for the filtered image pairs based on the converted item attributes; and
training, using the captions as labels, the machine learning model based on the filtered image pairs.

13. The computer-implemented method of claim 12, wherein extracting the item attributes comprises:
obtaining item data of a plurality of items from the training dataset; and
for each item of the plurality of items:
determining a product category of the item,
determining attributes associated with the product category,
extracting the attributes from item title, item description and item image of the item in the item data.

14. The computer-implemented method of claim 12, wherein converting the jargons comprises:
obtaining jargon definitions of different jargons;
removing stop words and most common words from the jargon definitions to generate filtered jargon definitions;
generating a vocabulary using unigram and bigram generated based on the filtered jargon definitions; and
mapping the jargons in the item attributes to conversational friendly keywords based on the vocabulary to generate the converted item attributes.

15. The computer-implemented method of claim 12, wherein generating the candidate image pairs comprises:
obtaining images of a plurality of items from the training dataset, wherein the images form a plurality of image pairs each including two images of two items; and
for each image pair including two respective images of two corresponding items:
computing a similarity score between the two respective images,
in accordance with a determination that the similarity score is higher than a predetermined threshold, add the image pair as a candidate image pair, wherein the two respective images in the candidate image pair act as reference image and target image, respectively, during the training process of the machine learning model.

16. The computer-implemented method of claim 12, wherein filtering the candidate image pairs comprises:
removing any candidate image pair whose two images share no common attribute; and
removing any candidate image pair whose two images have no different attribute.

17. The computer-implemented method of claim 12, wherein generating the captions comprises:
generating a direct caption for a first image pair including a first reference image and a first target image, wherein the direct caption directly refers to a desired or required attribute of the first target image which is different from the first reference image;
generating a relative caption for a second image pair including a second reference image and a second target image, wherein the relative caption includes a relative term to describe a difference regarding an attribute between the second target image and the second reference image; and
generating a negative caption for a third image pair including a third reference image and a third target image, wherein the negative caption specifies that an attribute in the third reference image is undesired by a user in the third target image.

18. The computer-implemented method of claim 10, further comprising:
obtaining, from the computing device, a new textual query after the target image is transmitted;
computing a new text embedding in the embedding space based on the new textual query;
determining the target image as a new reference image associated with the new textual query;
determining a new image embedding in the embedding space based on the target image;
determining, based on the at least one machine learning model, a new target image representing a third product based on the new text embedding and the new image embedding; and
transmitting the new target image to the computing device.

19. A non-transitory computer readable medium having instructions stored thereon,
wherein the instructions, when executed by at least one processor, cause at least one device to perform operations comprising:
obtaining, from a computing device, a search request identifying a reference image representing a first product and a textual query associated with the reference image;
computing a text embedding in an embedding space based on the textual query;
computing an image embedding in the embedding space based on the reference image;
determining, based on at least one machine learning model, a target image representing a second product based on the text embedding and the image embedding; and
transmitting, to the computing device, the target image in response to the search request.

20. The non-transitory computer readable medium of claim 19, wherein determining the target image comprises:
combining, using a machine learning model, the text embedding and the image embedding with weights pre-determined based on a training process of the machine learning model, to generate a combined embedding representing an aggregate of the textual query and the reference image in the embedding space; and
determining the target image based on the combined embedding using the machine learning model, wherein the target image is an image whose embedding is closest to the combined embedding in the embedding space.
